(19) United States
(12) Patent Application Publication
(10) Pub. No.: US 2022/0269953 A1
(43) Pub. Date: Aug. 25, 2022

(54) LEARNING DEVICE, PREDICTION SYSTEM, METHOD, AND PROGRAM

(71) Applicant: NEC Corporation, Minato-ku, Tokyo (JP)

(72) Inventor: Kunihiro TAKEOKA, Tokyo (JP)

(73) Assignee: NEC Corporation, Minato-ku, Tokyo (JP)

(21) Appl. No.: 17/638,984

(22) PCT Filed: Sep. 2, 2019
(86) PCT No.: PCT/JP2019/034345

§ 371 Date: Feb. 28, 2022

(51) Int. Cl. G06N 5/02

(52) U.S. Cl. CPC G06N 5/022

(57) ABSTRACT

An input unit 81 receives input of response data with a response attached to input data by each worker. A learning unit 82 learns a worker model which is a model that predicts a response to new input data using the input response data, for each worker. The input unit 81 receives input of both response data of first response data in which a label included in output candidate label data indicating a candidate label to be assigned to the input data is assigned to the input data, and second response data in which a label not included in the output candidate label data is assigned to the input data, and the learning unit 82 learns the worker model using the both response data of the first response data and the second response data.

### TECHNICAL FIELD

The present invention relates to a learning device, a learning method, and a learning program for learning a model for prediction using response results of workers obtained by crowdsourcing or the like, and to a prediction system, a prediction method, and a prediction program that perform predictions using the model.

### BACKGROUND ART

Supervised learning, represented by regression and classification, is used in various analytical processes such as, for example, prediction of demand for products in retail stores and classification of objects in images. In supervised learning, given pairs of inputs and outputs, the system learns the relationship between the inputs and the outputs, and given an input whose output is unknown, the system predicts an appropriate output based on the learned relationship.

In order to improve the prediction accuracy of supervised learning, it is necessary to provide a large number of pairs of input/output data. In particular, in classification, it is often necessary to ask an expert to assign a corresponding output (called a label) to each input (i.e., perform annotation). The problem is that the cost of hiring an expert is high and it takes a lot of time.

In order to solve this problem, for example, the techniques described in non-patent literature 1 and non-patent literature 2 have been proposed. Non-patent literature 1 and non-patent literature 2 describe requesting an unspecified number of people to perform a task by crowdsourcing or the like, which can collect a large number of pairs of input/output data at low cost, and learning a classifier using their response results.

Specifically, non-patent literature 2 describes a technique for learning a classifier from response results collected by crowdsourcing or the like. The technology described in the non-patent literature 2 differs from the technology described in the non-patent literature 1 in that it estimates a classifier (referred to as a worker model) corresponding to each worker, and constructs a prediction model from the worker model.

The technique described in non-patent literature 2 can improve the prediction accuracy of the learned classifier, because the responses of the worker can be estimated in more detail by assuming a worker model corresponding to the worker. In addition, since the prediction model is also prepared separately from the worker model, the estimation cost during prediction can be lowered.

### CITATION LIST

### Non-Patent Literature

NPL 1: Vikas C. Raykar, Shipeng Yu, Linda H. Zhao, Gerado Hermosillo, Charles Florin, Luca Bogoni, Linda Moy, “Learning from Crowds”, In Journal of Machine Learning Research, volume 11, pages 1297-1322.

NPL 2: Hiroshi Kajino, Yuta Tsuboi, Hisashi Kashima, “A Convex Formulation for Learning from Crowds”, In AAAI, volume 26, pages 73-79.

### SUMMARY OF INVENTION

### Technical Problem

On the other hand, the techniques described in the non-patent literatures 1 and 2 do not allow for responses other than output candidates to be included in the response results of the workers. If responses other than the output candidates are included, they are removed or otherwise processed in advance.

Therefore, in the techniques described in the non-patent literatures 1 and 2, when the number of responses from workers is small and there are workers who give responses other than the labels that are output candidates, it is difficult to estimate the worker model with high accuracy, and there is a problem that the prediction accuracy of the worker model decreases. In the following explanation, responses other than the labels that are output candidates are referred to as “unknown” responses.

For example, the technology described in non-patent literature 2 requires sufficient input data and response pairs to learn the worker model, and if the number of responses is small, learning becomes difficult. In addition, since the techniques described in non-patent literature 2 cannot use responses that are not included in the output candidate labels, the worker model must be learned from an even smaller number of input data and response pairs.

Therefore, it is an exemplary object of the present invention to provide a learning device, a learning method, and a learning program capable of learning a worker model for predicting worker responses with high accuracy, and a prediction system, a prediction method, and a prediction program that perform a prediction using the model.

### Solution to Problem

A learning device according to the exemplary aspect of the present invention includes an input unit which receives input of response data with a response attached to input data by each worker, and a learning unit which learns a worker model which is a model that predicts a response to new input data using the input response data, for each worker, wherein the input unit receives input of both response data of first response data in which a label included in output candidate label data indicating a candidate label to be assigned to the input data is assigned to the input data, and second response data in which a label not included in the output candidate label data is assigned to the input data, and the learning unit learns the worker model using the both response data of the first response data and the second response data.

A prediction system according to the exemplary aspect of the present invention includes the above-described learning device, a test data input unit which receives input of test data, and a prediction unit which predicts an output of the worker for the test data, using a worker model learned by the learning device.

A learning method according to the exemplary aspect of the present invention includes receiving input of response data with a response attached to input data by each worker, learning a worker model which is a model that predicts a response to new input data using the input response data, for each worker, when receiving the input of the response data, receiving input of both response data of first response data in which a label included in output candidate label data indicating a candidate label to be assigned to the input data is assigned to the input data, and second response data in which a label not included in the output candidate label data is assigned to the input data, and learning the worker model using the both response data of the first response data and the second response data.

A prediction method according to the exemplary aspect of the present invention includes performing a learning process based on the above-described learning method, receiving input of test data, and predicting an output of the worker for the test data, using a worker model learned by the learning process.

A learning program according to the exemplary aspect of the present invention causes a computer to execute, an input process of receiving input of response data with a response attached to input data by each worker, and a learning process of learning a worker model which is a model that predicts a response to new input data using the input response data, for each worker, wherein in the input process, the learning program causes the computer to receive input of both response data of first response data in which a label included in output candidate label data indicating a candidate label to be assigned to the input data is assigned to the input data, and second response data in which a label not included in the output candidate label data is assigned to the input data, and in the learning process, the learning program causes the computer to learn the worker model using the both response data of the first response data and the second response data.

A prediction program according to the exemplary aspect of the present invention causes a computer to execute, the above-described learning program, wherein the prediction program further causes the computer to execute a test data input process of receiving input of test data, and a prediction process of predicting an output of the worker for the test data using the worker model learned by executing the learning program.

### Advantageous Effects of Invention

According to the exemplary aspect of the present invention, it is possible to learn a worker model for predicting worker responses with high accuracy.

### BRIEF DESCRIPTION OF DRAWINGS

FIG. 1 It depicts a block diagram showing a configuration example of a learning device of a first exemplary embodiment according to the exemplary aspect of the present invention.

FIG. 2 It depicts an explanatory diagram showing an example of input data.

FIG. 3 It depicts an explanatory diagram showing an example of output candidate label data.

FIG. 4 It depicts an explanatory diagram showing an example of response data.

FIG. 5 It depicts an explanatory diagram schematically showing the true decision boundary and attributes of input data in a vector space.

FIG. 6 It depicts a flowchart showing an operation example of a learning device of the first exemplary embodiment.

FIG. 7 It depicts a block diagram showing a configuration example of a prediction system of a second exemplary embodiment according to the exemplary aspect of the present invention.

FIG. 8A It depicts an explanatory diagram showing an example of prediction results.

FIG. 8B It depicts an explanatory diagram showing an example of prediction results.

FIG. 8C It depicts an explanatory diagram showing an example of prediction results.

FIG. 9 It depicts a flowchart showing an operation example of a prediction system of the second exemplary embodiment.

FIG. 10 It depicts a block diagram showing a configuration example of a learning device of a third exemplary embodiment according to the exemplary aspect of the present invention.

FIG. 11 It depicts a flowchart showing an operation example of a learning device of the third exemplary embodiment.

FIG. 12 It depicts a block diagram showing a configuration example of a prediction system of a fourth exemplary embodiment according to the exemplary aspect of the present invention.

FIG. 13 It depicts a flowchart showing an operation example of a prediction system of the fourth exemplary embodiment.

FIG. 14 It depicts a block diagram showing an overview of a learning device according to the exemplary aspect of the present invention.

FIG. 15 It depicts a block diagram showing an overview of a prediction system according to the exemplary aspect of the present invention.

FIG. 16 It depicts a summarized block diagram showing a configuration of a computer for at least one exemplary embodiment.

### DESCRIPTION OF EMBODIMENTS

Hereinafter, exemplary embodiments of the present invention are described with reference to the drawings. In the following description, a case where annotation (i.e., the task of labeling each data) is performed by a crowdsourcing service is illustrated. Each entity that performs annotation is described as a worker (operator), and the model that predicts the response of each worker to new input data is described as a worker model. In other words, in this exemplary embodiment, annotation is performed by each worker, and a worker model that predicts the responses of each annotated worker is learned.

However, the present invention is not limited to the case where the annotation is performed by a crowdsourcing service. Any person in charge can take the initiative to perform the annotation.

### Exemplary Embodiment 1

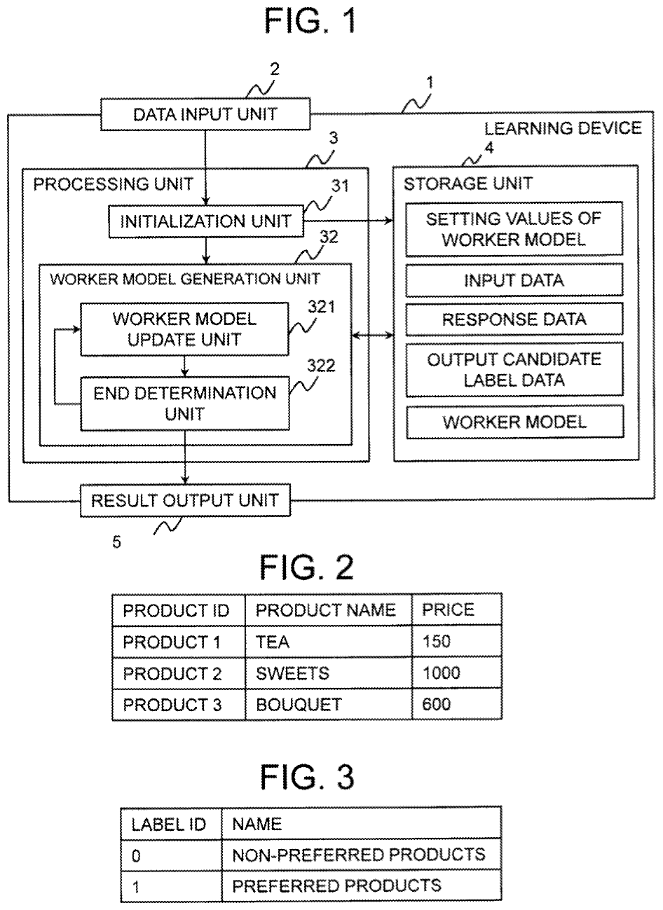

FIG. 1 is a block diagram showing a configuration example of a learning device of a first exemplary embodiment according to the exemplary aspect of the present invention. The learning device 1 of this exemplary embodiment comprises a data input unit 2, a processing unit 3, a storage unit 4, and a result output unit 5. The unidirectional arrows shown in FIG. 1 are a straightforward indication of the direction of information flow, and do not exclude bidirectionality.

First, the data given in advance in the present invention will be described. In the present invention, input data, output candidate label data, and response data are given. The input data is un-labeled data to which a label is to be assigned (annotated) by a worker, for example. The output candidate label data is a candidate for a label to be assigned to the input data, and is predetermined according to the target to be assigned. The output candidate label data may also be referred to as label data. The response data may also be referred to as annotation results.

The input data, the output candidate label data, and the response data each contain a plurality of records. Hereinafter, the ID of each record of the input data is referred to as the input ID, and the ID of the worker to distinguish the worker in the response data is referred to as the worker ID. Also, the ID of each record of the output candidate label data is referred to as the label ID or label.

In each record of input data, an input ID is associated with an attribute of the input corresponding to that input ID. In addition, in each record of the response data, the input ID, the worker ID, and the response corresponding to them are associated with each other. The responses corresponding to the input ID and worker ID are labels indicating either one of the label IDs or an “unknown” response. In other words, a label indicating an “unknown” response is a label indicating a response that is not included in the output candidate label data.

FIG. 2 is an explanatory diagram showing an example of input data. The input data shown in FIG. 2 illustrates “Product name” and “Price” as attributes corresponding to a product ID (input ID). The attributes of the input data may be converted in advance into a numeric vector or the like that becomes a feature value. The input data illustrated in FIG. 2 can be said to be product data.

FIG. 3 is an explanatory diagram showing an example of output candidate label data. In FIG. 3, a label ID and “Name” as a corresponding attribute are illustrated for each record of the output candidate label data. In the example shown in FIG. 3, labels of non-preferred products and preferred products are shown as the output candidate label data, and each of them has a label ID of “0” and “1”, respectively.

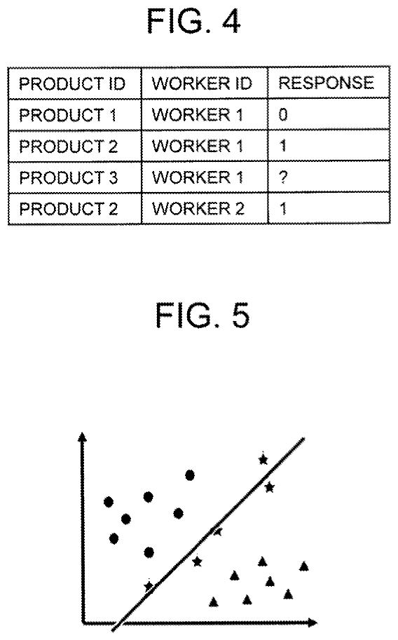

FIG. 4 is an explanatory diagram showing an example of response data. In FIG. 4, an example of response data showing a response corresponding to the product ID associated with the input ID, and the worker ID is shown. In the example shown in FIG. 4, the worker identified by the worker ID is asked what response to give to the product identified by the product ID (input ID). The response is indicated by the label ID or “?” in the output candidate label data illustrated in FIG. 3. It should be noted that “?” indicates a response of “unknown”.

For example, the example shown in FIG. 4 indicates that “Worker 1” responses “Non-preferred” for “Product 1”, while “Preferred” for “Product 2”. The example shown in FIG. 4 also indicates that “Worker 1” responses “unknown” for “Product 3”.

Next, the learning and prediction of the classifier that performs classification will be described. Classification is one type of supervised learning, which is the task of predicting the relationship between the input and a finite number of output candidate labels. In classification, it is assumed that the same label is output for data with similar properties.

Learning a classifier is to estimate the parameters of the classifier by optimizing the parameters of the classifier with respect to some index using a given pairs of inputs and outputs (learning data set). For example, a loss function is defined as an index to be optimized, and the parameters of the classifier that minimize the loss function are estimated. At the time of prediction, for a newly given input, the classifier is operated based on the learned parameters, and the prediction result corresponding to the input is output.

The loss function is a function that outputs how close the predicted results of the classifier with the current parameter values are to the output of the learning data set.

The first exemplary embodiment describes a learning process in the case where input data, output candidate label data, and response data as described above are given. First, an overview of the learning device 1 of the first exemplary embodiment will be described.

The learning device 1 inputs input data, output candidate label data, and response data. The response data includes the response data of one or more workers. In addition, some records of the response data include labels as responses that are not included in the output candidate label data. As described above, the labels that are not included in the output candidate label data are referred to here as “unknown” responses.

In the description of the first exemplary embodiment, reference is made to the input data illustrated in FIG. 2, the output candidate label data illustrated in FIG. 3, and the response data illustrated in FIG. 4. The input data may show attributes other than those illustrated in FIG. 2. The values of the attributes may be images, sounds, or the like. In addition, although FIG. 2 illustrates product data, the input data is not limited to product data.

Similarly, attributes other than those illustrated in FIG. 3 may be indicated in the output candidate label data. Also, the number of records of the output candidate label data is not limited to two, but may be three or more. In other words, the class to be classified may be multi-class.

The response data is data that shows the relationship between the input ID and the label ID, and what kind of response the worker made to the data of which input ID. It is assumed that the response data used in the present invention includes “unknown” responses in some records of the response data. In FIG. 4, “0,” “1” and “?” which is an “unknown” response are illustrated.

Then, in this exemplary embodiment, when learning the worker model, the prediction accuracy of the response of the worker by the worker model is improved by utilizing the fact that the values of the attributes of the input data corresponding to the “unknown” response are distributed around the decision boundary of the worker model. The decision boundary of the worker model can be said to be the separation boundary that separates the input data groups by the worker. This will be described in detail below using the drawings.

FIG. 5 is an explanatory diagram schematically showing the true decision boundaries and attributes of input data in a vector space. The star marks illustrated in FIG. 5 indicate the input data to which the worker responded “unknown”. The circle or triangle marks illustrated in FIG. 5 indicate input data that was responded with one of the responses indicated by the output candidate labels.

The worker model to be estimated, i.e., the true decision boundary assumed by the worker, is assumed to be distributed around the attributes of the input data corresponding to the data that responded “unknown”. The learning device 1 of this exemplary embodiment uses this to learn a worker model that can improve prediction accuracy. In this exemplary embodiment, the following step S101 to step S103 are performed as the learning process.

Specifically, the learning device 1 prepares a worker model corresponding to the worker ID of the response data, and initializes the parameters of the worker model (step S101). The learning device 1 updates the parameters of the worker model to reduce the value of the loss function based on some or all of the response data, currently defined parameters of the worker model, and a loss function that introduces a term that explicitly treats “unknown” response of the worker (step S102). The learning device 1 repeats the process of this step S102 until the condition for determining termination is satisfied, and when the condition is satisfied, the worker model including the learned parameters is output (step S103).

The process performed by each configuration included in the learning device 1 is described below.

The data input unit 2 receives input of response data with a response attached to input data by each worker. Specifically, the data input unit 2 receives input of a group of data used for learning the worker model and setting values of the worker model. As described above, the worker model is a model that predicts a response of the worker. The setting values of the worker model include, for example, attributes to be used as explanatory variables in the worker model and the type of the worker model. The types of worker models include, for example, support vector machine and logistic regression. In the setting values of the worker model, one of the various models is specified as the type of the worker model.

The data input unit 2 may access an external device (not shown) to obtain the group of data and the setting values of the worker model, for example. The data input unit 2 may also be an input interface through which the group of data and the setting values of the worker model are input.

The group of data used for learning the worker model includes input data (for example, product data illustrated in FIG. 2), predetermined output candidate label data (for example, output candidate label data illustrated in FIG. 3), and response data (for example, response data illustrated in FIG. 4). The response data includes, in some records, values (responses of “unknown”) for the responses that are not included in the output candidate labels.

In other words, the data input unit 2 receives input of both response data in which labels included in the output candidate label data are assigned to the input data (hereinafter, sometimes referred to as the first response data) and response data in which labels not included in the output candidate label data are attached to the input data (hereinafter, sometimes referred to as the second response data).

The technology described in the non-patent literature 1 does not allow for the presence of values other than the output candidate labels in the values of the responses in the response data. Therefore, it can be said that this exemplary embodiment differs from the technology described in the non-patent literature 1 in that this exemplary embodiment includes responses (i.e., “unknown” responses) that are not included in the output candidate labels in some records.

The processing unit 3 performs a process of learning a worker model. Specifically, the processing unit 3 learns the worker model of the worker for the input worker response data. The processing unit 3 includes an initialization unit 31 and a worker model generation unit 32.

The initialization unit 31 receives input data, output candidate label data, response data, and setting values of the worker model from the data input unit 2, and stores them in the storage unit 4. In addition, the initialization unit 31 initializes various parameters used for learning the worker model. The initialization unit 31 can initialize the various parameters according to the learning method of the worker model.

The worker model generation unit 32 learns a worker model by repeat processing. The processes performed by each unit of the worker model generation unit 32 are described below. The worker model generation unit 32 has a worker model update unit 321 and an end determination unit 322.

The worker model update unit 321 updates the parameters of the worker model based on the input data, the output candidate label data, the response data, the currently set parameters of the worker model, and the specified loss function. At this time, the worker model update unit 321 may use some or all of the response data.

The loss function of this exemplary embodiment uses the response data with a label (the label of “unknown”) that is not included in the output candidate labels. In other words, the worker model update unit 321 learns the worker model using both of the first response data and the second response data described above. The loss function includes a loss term calculated using a pair of the response data (i.e., the first response data) for which one of the output candidate labels is a response and the corresponding input data, and a loss term calculated using the “unknown” response data (i.e., the second response data) that is not included in the output candidate labels. The worker model update unit 321 can update the parameters of the worker model using a known method.

If there are multiple worker IDs in the response data, the worker model update unit 321 updates the parameters described above for the response data, input data, and the worker model corresponding to each worker ID.

The worker model update unit 321 may update the parameters of the worker model using Equation 1 shown below, for example. In Equation 1, Dⱼ represents a set of pairs of input data corresponding to the responses of the labels included in the output candidate label data among the responses by the worker j, and Uⱼ represents a set of pairs of input data corresponding to the response “unknown”. In addition, gⱼ is the worker model corresponding to worker j, and its parameter is θⱼ. L is a loss function and is represented by Equation 2 shown below, for example.

$$\begin{matrix}[ Math . 1 ] & \\ {θ}_{j}^{( t + 1 )} = {θ}_{j}^{( t )} + η \frac{\partial L ( {g}_{j} , {D}_{j} , {U}_{j} )}{\partial {θ}_{j}} & ( Equation 1 )\end{matrix}$$

$$L ( {g}_{j} , {D}_{j} , {U}_{j} ) = {\sum }_{{x}_{i} , {y}_{j} ∈ {D}_{j}} l ( {y}_{ij} , {g}_{j} ( {x}_{j} ; {θ}_{j} ) ) + λ {\sum }_{{x}_{i} ∈ {U}_{j}} Ω ( {g}_{j} ( {x}_{i} ; {θ}_{j} ) ) \qquad ( Equation 2 )$$

In Equation 2, xᵢ represents the i-th data and yᵢⱼ represents a response the worker j to the i-th input data. In addition, l(a,b) is a function that calculates the loss of predicting b when the true output is a, and L(g,D,U) represents the loss function of model g in response data D, U. And Ω(⋅) represents the loss function for the “unknown” response, and η and λ are hyperparameters for updating parameters and calculating the loss function.

Thus, the loss function may include a loss term that evaluates the proximity of the second response data and the separation boundary that separates the input group of data by the worker. Then, the worker model update unit 321 may learn the worker model based on the loss function with the added loss term that evaluates the output of the worker model for the second response data (input data included in the second response data).

The end determination unit 322 determines whether or not to end the repetition of the parameter updating process by the worker model update unit 321. The end determination unit 322 determines that the repetition of the above series of processes is to be ended when the end condition is satisfied, and determines that the repetition is to be continued when the end condition is not satisfied.

For example, the number of repetitions of the above series of processes may be set in the setting values of the worker model. In this case, the end determination unit 322 may determine that the repetition is to be ended when the number of repetitions of the above series of processes reaches the set number of times.

The storage unit 4 is a storage device for storing various data obtained by the data input unit 2 and various data obtained by the processing unit 3. The storage unit 4 may be a main memory of a computer or a secondary memory. When the storage unit 4 is a secondary memory, the worker model generation unit 32 can suspend the processing in the middle and store the data in the middle in the storage unit 4, and then restart the processing. The storage unit 4 may be configured to be divided into a main memory and a secondary memory. In this case, the processing unit 3 may store some of the data in the main memory and other data in the secondary memory. The storage unit 4 is realized by a magnetic disk or the like, for example.

The result output unit 5 outputs the result of the processing by the worker model generation unit 32. Specifically, the result output unit 5 outputs the worker model and the learned parameters stored in the storage unit 4 as a result of the processing.

The manner in which the result output unit 5 outputs the results is not particularly limited. For example, the result output unit 5 may output the result to another device (not shown), or may display the result on a display device.

The worker model generation unit 32 having the worker model update unit 321 and the end determination unit 322, the data input unit 2, the initialization unit 31, and the result output unit 5 are, for example, realized by a processor (for example, a CPU (Central Processing Unit), a GPU (Graphics Processing Unit)) of a computer that operates according to a program (learning program).

In this case, the processor reads a program from a program recording medium such as a program storage device of a computer (not shown), for example, and operates as the data input unit 2, the initialization unit 31, the worker model generation unit 32 (more particularly, the worker model update unit 321 and the end determination unit 322), and the result output unit 5 according to the program. In addition, the functions of the learning device 1 may be provided in the form of SaaS (Software as a Service).

The data input unit 2, the initialization unit 31, the worker model generation unit 32 (more particularly, the worker model update unit 321 and the end determination unit 322), and the result output unit 5 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the learning device 1 is realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

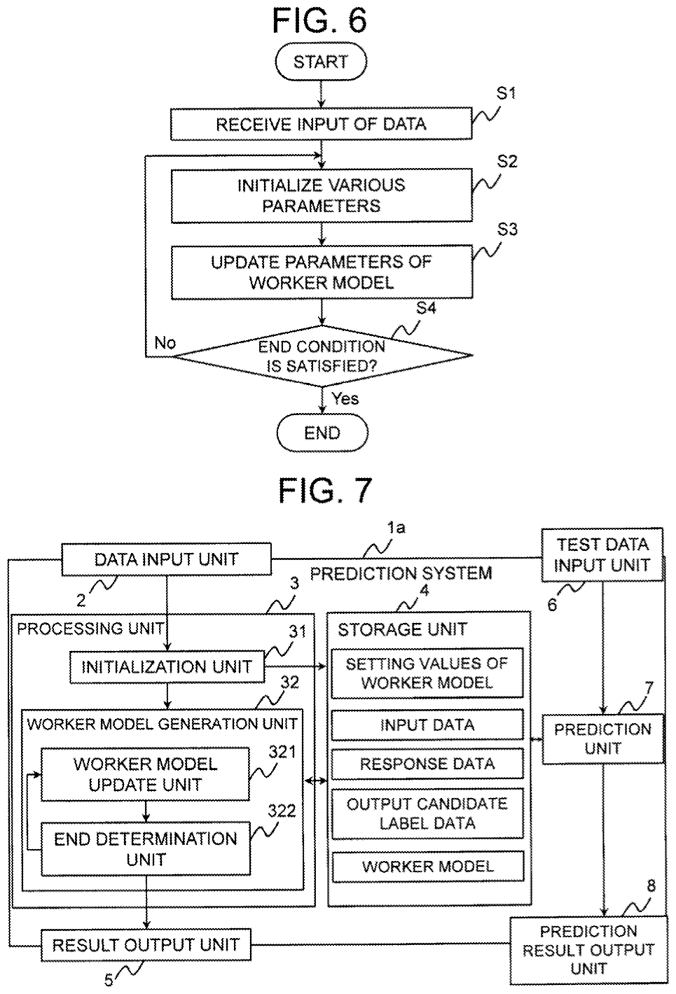

Next, the operation of the learning device 1 of this exemplary embodiment will be described. FIG. 6 is a flowchart showing an operation example of the learning device 1 of the first exemplary embodiment.

The data input unit 2 receives input of a set of data (input data, output candidate label data, and response data) used for learning the worker model, as well as input of setting values of the worker model (step S1).

The initialization unit 31 stores the input data, the output candidate label data, the response data, and the setting values of the worker model in the storage unit 4. In addition, the initialization unit 31 sets initial values for the parameters of the worker model and stores the initial values in the storage unit 4 (step S2).

In step S2, the initialization unit 31 may arbitrarily set the initial value, or may set the initial value according to random numbers. After step S2, the worker model generation unit 32 repeats the processes of step S3 and step S4 until the end condition is satisfied. The processes of step S3 and step S4 are described below.

The worker model update unit 321 refers to the information stored in the storage unit 4 and, based on the input data and the response data, learns a worker model that predicts the response corresponding to the worker ID. Then, the worker model update unit 321 stores each worker model obtained by the learning in the storage unit 4 (step S3).

Next, the end determination unit 322 determines whether or not the end condition has been satisfied (step S4). When the end condition has not been satisfied (No in step S4), the end determination unit 322 determines that step S3 is repeated. Then, the worker model generation unit 32 executes the processes of step S3 and step S4 again.

On the other hand, when the end condition is satisfied (Yes in step S4), the end determination unit 322 determines that the repetition of step S3 is to be ended. In this case, the result output unit 5 outputs the result of the processing by the worker model generation unit 32 at that point in time, and the processing by the learning device 1 is ended.

As described above, in this exemplary embodiment, the data input unit 2 receives input of response data generated in such a manner that a response is attached to input data by each worker, and the worker model generation unit 32 learns a worker model for each worker using the input response data. In that case, the data input unit 2 receives input of both first response data and second response data, and the worker model generation unit 32 learns the worker model using the response data from both the first response data and the second response data. Thus, it is possible to learn a worker model for predicting worker responses with high accuracy.

That is, in this exemplary embodiment, when the worker model update unit 321 generates the worker model by referring to the input data, the output candidate label data, and the response data, the record of the “unknown” response in the response data and the corresponding input data are used for learning the worker model. Therefore, it is possible to utilize the fact that the input data corresponding to the “unknown” response is near the decision boundary of the worker model, and the prediction accuracy of the worker model can be further improved.

### Exemplary Embodiment 2

Next, a second exemplary embodiment of the present invention will be described. The second exemplary embodiment describes a configuration of a prediction system for predicting a response of the worker using a worker model generated in the first exemplary embodiment. The prediction system of this exemplary embodiment generates a worker model by repeating the process of step S3 and step S4 above, for example, and then predicts the response of the worker to test data using the generated worker model and the given new input data (hereinafter, sometimes referred to as test data).

FIG. 7 is a block diagram showing a configuration example of a prediction system of a second exemplary embodiment according to the exemplary aspect of the present invention. The same sign as in FIG. 1 is attached to the same configuration as in the first exemplary embodiment, and the description is omitted. The prediction system 1a of the second exemplary embodiment, in addition to the data input unit 2, the processing unit 3, the storage unit 4, and the result output unit 5, further includes a test data input unit 6, a prediction unit 7, and a prediction result output unit 8.

Here, it is assumed that the processing unit 3 has completed the learning process described in the first exemplary embodiment and the worker model has been generated.

The test data input unit 6 receives input of test data. The input of the test data may include a worker ID. If the worker ID is not included, the prediction result output unit 8 described below should output the result of predicting the responses of the workers corresponding to all the worker IDs in the response data.

The test data input unit 6 may access an external device (not shown) to obtain the test data, for example. The test data input unit 6 may also be an input interface through which the test data is input.

The test data includes the input ID and the value of each attribute in the same way as the input data. The test data is in the same format as the input data. For example, when a worker model is learned using the data illustrated in FIG. 2 as input data and all attributes as explanatory variables, the test data also requires the same attributes “Product name” and “Price” as the data illustrated in FIG. 2. It is assumed that the values of each attribute of the test data are defined in the same way as the input data.

For the test data and the specified worker IDs, the prediction unit 7 predicts worker responses using the worker model corresponding to the worker IDs. If one or more of the worker IDs in the response data are specified, the prediction unit 7 predicts each response of the worker corresponding to the worker ID using the worker model corresponding to the specified worker ID. The predicted worker response may be any of the labels in the output candidate label data. In addition, the prediction unit 7 may output a probability (hereinafter, referred to as an affiliation probability) for each of the output candidate labels as a prediction of the response of the worker output based on the test data and the worker model.

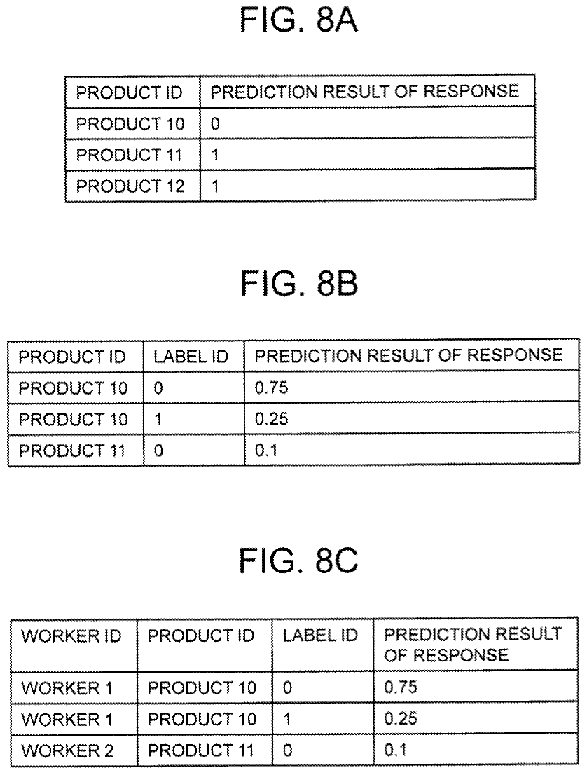

FIGS. 8A-8C are explanatory diagrams showing examples of prediction results corresponding to one data included in the test data. FIG. 8A shows an example of outputting the most suitable label among the output candidate labels. On the other hand, FIG. 8B shows an example of an affiliation probability for all the labels included in the output candidate label data, i.e., a value representing the degree to which the data matches each label. FIG. 8C shows an example of an affiliation probability for each worker.

The prediction result output unit 8 outputs the value predicted by the prediction unit 7. The manner in which the prediction result output unit 8 outputs the predicted value is not particularly limited. For example, the prediction result output unit 8 may output the predicted value to another device (not shown), or may display the predicted value on a display device.

The test data input unit 6, the prediction unit 7, and the prediction result output unit 8 are also realized, for example, by a processor of a computer that operates according to a program (prediction program).

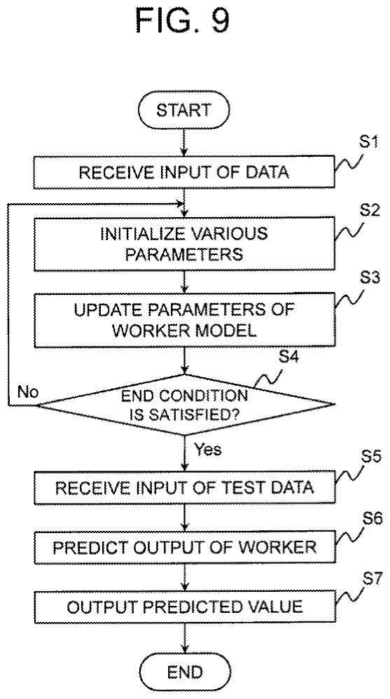

Next, the operation of the prediction system of this exemplary embodiment will be described. FIG. 9 is a flowchart showing an operation example of the prediction system of the second exemplary embodiment. The process up to the generation of the worker model is the same as the processes from step S1 to step S4 illustrated in FIG. 6.

The test data input unit 6 receives input of test data (step S5). The prediction unit 7 predicts an output of the worker for the test data using the learned worker model (step S6). Then, the prediction result output unit 8 outputs the value predicted by the prediction unit 7 (step S7).

As described above, in this exemplary embodiment, the test data input unit 6 receives the input of test data, and the prediction unit 7 predicts the output of the worker to the test data using the learned worker model. Thus, in addition to the effect of the first exemplary embodiment, the response to the test data of the worker can be predicted. That is, for the given test data and the specified worker ID, the response to the test data of the worker corresponding to the worker ID can be predicted.

### Exemplary Embodiment 3

Next, a third exemplary embodiment of the present invention will be described. In the first exemplary embodiment, a method for learning a worker model that predicts the responses of each worker respectively is described. In this exemplary embodiment, a method of learning a model (hereinafter, referred to simply as a prediction model) that predicts the responses of any user regardless of the worker who gave the responses is described. Specifically, the learning device of this exemplary embodiment simultaneously learns a worker model and a prediction model when input data, output candidate label data, and response data are given.

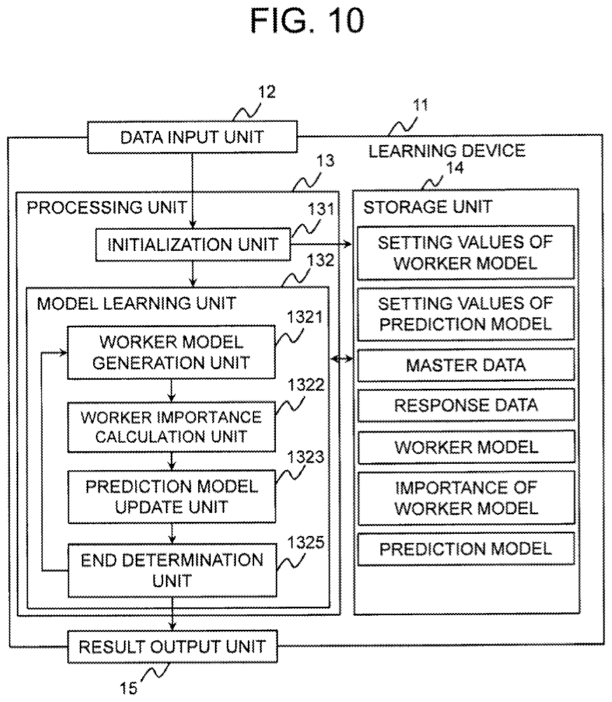

FIG. 10 is a block diagram showing a configuration example of a learning device of a third exemplary embodiment according to the exemplary aspect of the present invention. The learning device 11 of the third exemplary embodiment comprises a data input unit 12, a processing unit 13, a storage unit 14, and a result output unit 15. The unidirectional arrows shown in FIG. 10 are straightforward indications of the direction of the flow of information, and do not exclude bidirectionality.

First, at the outset, an overview of the learning device 11 of the third exemplary embodiment will be described. The learning device 11 holds a worker model corresponding to each worker ID and a learned prediction model. The worker model and the prediction model typically use the same type of classifier model, but do not necessarily have to be the same type of model.

Specifically, the learning device 11 inputs input data, output candidate label data, and response data that includes “unknown” responses in some records, and holds a worker model and a prediction model corresponding to each worker ID included in the response data. In this exemplary embodiment, as in the first exemplary embodiment and second exemplary embodiment, the prediction accuracy of the worker model responses is improved by using the “unknown” responses to generate the worker model.

Further, in this exemplary embodiment, the learning device 11 calculates the importance of the worker by using the “unknown” response tendency of the worker included in the response data in addition to the information of the worker model. By updating the prediction model using this worker importance, the prediction accuracy of the prediction model is improved.

In this exemplary embodiment, as a learning process, the following steps S210 to S230 are performed as the learning process. It should be noted that some explanations are omitted for the processes similar to the first exemplary embodiment.

Specifically, as in the first exemplary embodiment, the learning device 11, for each worker ID included in the record of the response data, prepares a worker model corresponding the worker ID and initializes its parameters. In addition, the learning device 11 also initializes the parameters of the prediction model (step S210).

As the processing of step S220, the following steps S221 to step S223 are performed. First, the learning device 11 updates the parameters of the worker model by referring to the input data, the output candidate label data, and the response data, as in the first exemplary embodiment. Alternatively, the learning device 11 may use the information of the prediction model to update the parameters of the worker model as in the method described in the non-patent literature 2, for example (step S221).

Next, the learning device 11 updates importance of the worker based on the information of the worker model and the response data. The information of the worker model includes the parameters of the worker model and the like. In addition, the response data includes the results of which inputs each worker responded to. For example, if the worker of interest responses “unknown” even though other workers response other than “unknown,” the learning device 11 may update the importance of the worker of interest to be lowered. The learning device 11 may also calculate the importance of the worker using, for example, the distance between the result of estimating the response of the worker using the information of the worker model and the result of the majority vote of responses of the other workers. In this case, the learning device 11 updates the importance of the worker so that the closer the distance, the higher the importance of the worker. The learning device 11 may refer to the information of the prediction model to update the importance of the worker. For example, the learning device 11 may calculate the importance of the worker using the difference (distance) between the result estimated using the information of the prediction model and the result estimated using the information of the worker model. In this case, the learning device 11 updates the importance of the worker so that the closer the distance, the higher the importance of the worker (step S222).

The learning device 11 updates the prediction model based on the input data, the response data, the worker model, and the importance of the worker. For example, when the worker model and the prediction model are logistic regression, the learning device 11 may update the parameters of the prediction model by a weighted sum of the worker model. For example, the prediction model may be realized by a weighted sum of the worker models (step S223).

The learning device 11 repeats the process of this step S220 until the condition of the end determination is satisfied, and when the condition is satisfied, the learned worker model and prediction model are output (step S230).

The process performed by each configuration included in the learning device 11 is described below.

The data input unit 12 receives input of a group of data used for learning the worker model and the prediction model, and setting values of the worker model and the prediction model. The data input unit 12 may access an external device (not shown) to obtain the group of data and the setting values of the worker model and the prediction model, for example. The data input unit 12 may be an input interface through which the group of data and the setting values of the worker model and the prediction model are input.

The contents of the group of data are the same as in the first exemplary embodiment. That is, the group of data includes input data, output candidate label data, and response data. In the response data, in some records, the value of the response includes a value (a response of “unknown”) that is not included in the output candidate label.

The setting values for the worker model and prediction model include the attributes that are explanatory variables in the worker model, the attributes that are explanatory variables in the prediction model, the type of worker model, and the type of prediction model, for example.

As described above, a prediction model is a model used to predict the output corresponding to the input data, and similar to the worker model in the first exemplary embodiment, one of various prediction models is specified as the type of prediction model.

The processing unit 13 performs a process of learning a worker model and a prediction model. The processing unit 13 includes an initialization unit 131 and a model learning unit 132.

The initialization unit 131 receives the input data, the response data, and the setting values of the worker model and the prediction model from the data input unit 12, and stores them in the storage unit 14. In addition, the initialization unit 131 initializes various parameters used for learning the worker model and the prediction model. The initialization unit 131 can initialize the various parameters according to the learning methods of the worker model and the prediction model.

The model learning unit 132 learns the worker model and the prediction model by repeat processing. The process performed by each unit of the model learning unit 132 is described below. The model learning unit 132 includes a worker model generation unit 1321, a worker importance calculation unit 1322, a prediction model update unit 1323, and an end determination unit 1325.

For each worker ID of the response data that generates each worker model, the worker model generation unit 1321 takes the attributes of the input data as input and learns a worker model that outputs the response of the corresponding worker ID. The method by which the worker model generation unit 1321 generates the worker models is the same as in the first exemplary embodiment. The worker model generation unit 1321 may use a prediction model for learning the worker model.

The worker importance calculation unit 1322 calculates, for each worker ID included in the response data and the corresponding worker model, the importance of the worker model. In general, since each worker has different expertise, treating worker models equally leads to a decrease in the prediction accuracy of the prediction model. In this exemplary embodiment, when calculating the importance of the worker model, the worker importance is calculated more accurately by using the “unknown” responses that are not included in the output candidate label data.

For example, if there is a worker who has a high percentage of “unknown” responses even though no other worker has responded “unknown”, the importance of that worker can be estimated to be lower than that of other workers because that worker may have low expertise in the input data and may not have been able to make a decision. Therefore, it can be said that the worker importance is a value that indicates the degree of reliability of the worker model. Therefore, the worker importance calculation unit 1322 may calculate the worker importance so that the worker importance is higher the lesser the second response data is.

The worker importance calculation unit 1322 refers to the information of the worker model and the response data, and calculates prediction accuracy for each worker using the information of the worker model. Specifically, the worker importance calculation unit 1322 calculates the worker importance for each worker according to the number of responses to the second response data by the worker. The worker importance calculation unit 1322 may calculate the worker importance for each worker according to the ratio of the number of responses to the first response data by the worker and the number of responses to the second response data by using the first response data. In this case, the worker importance calculation unit 1322 calculates the worker importance higher the greater the number of responses to the first response data. Similarly, the worker importance calculation unit 1322 may calculate the worker importance using the degree of agreement between the results estimated using the parameters of the worker model and the first response data of the worker. In this case, the worker importance calculation unit 1322 calculates a higher worker importance as the degree of agreement is higher. The worker importance calculation unit 1322 may also estimate prediction accuracy of the worker model by referring to the information of the worker model and the first response data, and use the prediction accuracy as the worker importance. This allows the reliability of the worker model itself to be estimated. In addition, by referring to the response data, it becomes possible to calculate worker importance using the number of “unknown” responses described above. The information of the prediction model may also be used to calculate the importance of the worker. In the case of using the information of the prediction model, the worker importance calculation unit 1322 may predict the worker responses to the given data using the information of the worker model, measure the degree of agreement with the prediction results of the prediction model and calculate the worker importance using the degree of agreement, for example. In this case, the worker importance calculation unit 1322 calculates the worker importance higher the higher the degree of agreement.

The worker importance calculation unit 1322 may calculate the importance for worker j using Equation 3 shown below, for example. In Equation 3, wⱼ represents the importance of worker j, and Pⱼ represents the accuracy of the worker model for the response of the output candidate label data in the response data. In addition, as mentioned above, Uⱼ is a set of pairs of input data corresponding to the “unknown” response of worker j in the response data. By Equation 3, the importance of a worker is calculated according to the number of times the worker made an “unknown” response and the accuracy of the worker to the response data.

$$\begin{matrix}[ Math . 2 ] & \\ {w}_{j} = \frac{{P}_{j}}{exp \{ - \vert {U}_{j} \vert \}} & ( Equation 3 )\end{matrix}$$

The prediction model update unit 1323 updates the prediction model stored in the storage unit 4, referring to the learned worker model and the calculated worker importance. The prediction model is obtained by the worker model and its importance. The prediction model update unit 1323 may weight the worker model by the corresponding worker importance and generate the prediction model using the weighted worker model. That is, the prediction model update unit 1323 may update the parameters of the prediction model with a weighted average that takes into account the corresponding worker importance for the parameters of the worker model, for example.

The model learning unit 132 repeats the process by the worker model generation unit 1321, the process by the worker importance calculation unit 1322, and the process by the prediction model update unit 1323.

The end determination unit 1325 determines whether or not to end the repetition of the parameter update process by the model learning unit 132. The end determination unit 1325 determines that the repetition of the above series of processes is to be ended when the end condition is satisfied, and determines that the repetition is to be continued when the end condition is not satisfied.

For example, as in the first exemplary embodiment, the number of repetitions of the above series of processes may be determined in the setting values of the prediction model. In this case, the end determination unit 1325 may determine that the repetition is ended when the number of repetitions of the above series of processes reaches the setting number of times. Alternatively, the end determination unit 1325 may also make the end determination according to the amount of change in the parameter update.

The contents of the storage unit 14 and the result output unit 15 are the same as those of the storage unit 4 and the result output unit 5 in the first exemplary embodiment and the second exemplary embodiment. It should be noted that he result output unit 15 of this exemplary embodiment outputs a part or all of the worker model and the prediction model obtained as a result of the processing.

As in the first exemplary embodiment, the model learning unit 132 including the worker model generation unit 1321, the worker importance calculation unit 1322, the prediction model update unit 1323, and the end determination unit 1325, the data input unit 12, the initialization unit 131, and the result output unit 15 are realized by a processor of a computer that operates according to a program (learning program), for example.

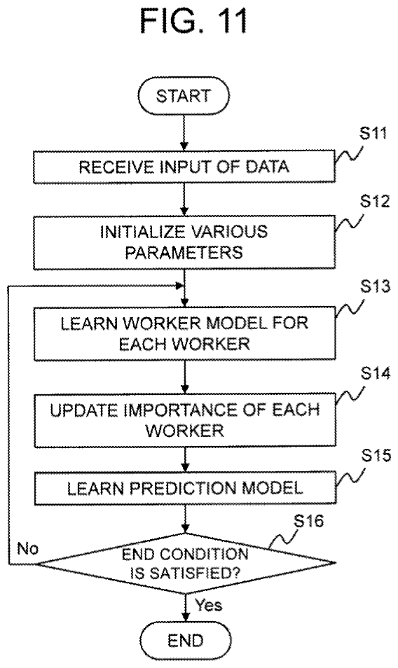

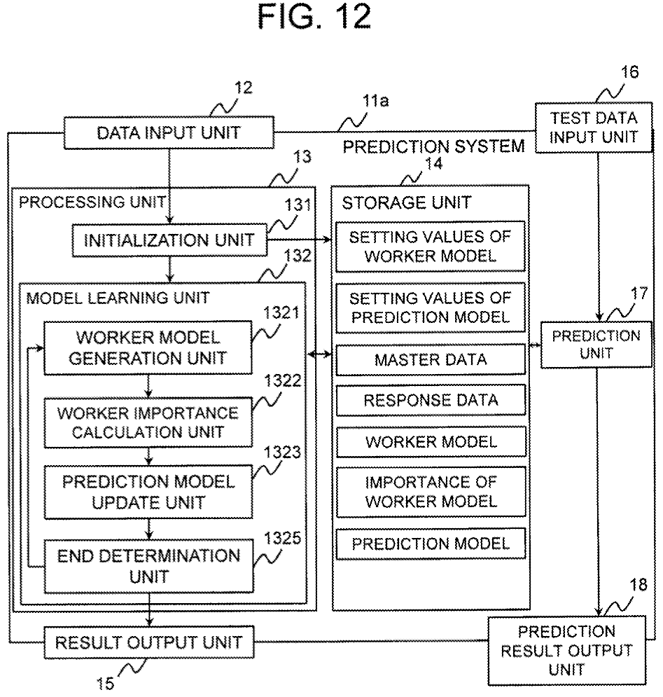

Next, the operation of the learning device 11 of this exemplary embodiment will be described. FIG. 11 is a flowchart showing an operation example of the learning device 11 of the third exemplary embodiment.

The data input unit 12 receives input of a set of data (input data and response data) used for learning the worker model and the prediction model, and setting values of the worker model and the prediction model (step S11).

The initialization unit 131 stores the input data, the response data, and the setting values of the worker model and the prediction model in the storage unit 14. In addition, the initialization unit 131 sets initial values for the parameters of the worker model, the worker importance, and the prediction model, and stores the initial values in the storage unit 14 (step S12).

In step S12, the initialization unit 131 may set the initial values arbitrarily, and may determine a random number for each worker to determine the parameter. For example, the initialization unit 131 may divide the number of responses for each worker by the number of records of the response data and set the divided value as the initial values of the worker importance. The initialization unit 131 may also, for example, determine the initial values of the parameters of the prediction model by random numbers.

After step S12, the model learning unit 132 repeats steps S13 to S17 is repeated until the end condition is satisfied. The processes of steps S13 to S17 are described below.

The worker model generation unit 1321 learns a worker model for each worker based on the input data and the response data, referring to information stored in the storage unit 14. Then, the worker model generation unit 1321 stores each worker model obtained by the learning in the storage unit 14 (step S13).

The worker importance calculation unit 1322 updates the importance of each worker stored in the storage unit 14 (step S14). Specifically, in step S14, the worker importance calculation unit 1322 reads the information on the worker model and the response data stored in the storage unit 14, and determines a new importance for each worker based thereon. If the importance of the worker model has not been set, the worker importance calculation unit 1322 does not need to perform the processing of step S14. Then, the worker importance calculation unit 1322 stores the calculated worker importance in the storage unit 14.

Next, the prediction model update unit 1323 updates the prediction model, referring to the worker model of each worker ID and the worker importance of each worker ID. Specifically, the prediction model update unit 1323 updates the model information of the prediction model stored in the storage unit 14 with the updated model information of the prediction model (step S15).

Next, the end determination unit 1325 determines whether or not the end condition has been satisfied (step S16). When the end condition has not been satisfied (No in step S16), the end determination unit 1325 determines that steps S13 to S16 are repeated. Then, the model learning unit 132 executes the processes of steps S13 to S16 again.

On the other hand, when the end condition is satisfied (Yes in step S16), the end determination unit 1325 determines that the repetition of steps S13 to S16 is ended. In this case, the result output unit 15 outputs the result of the processing by the model learning unit 132 at that point in time, and the processing by the learning device is ended.

As described above, in this exemplary embodiment, the worker importance calculation unit 1322 calculates for each worker a worker importance indicating a degree of reliability of the worker model according to the number of responses to the second response data by the worker, and the prediction model update unit 1323 generates a prediction model based on the worker model and the calculated worker importance. Thus, in addition to the effect of the first exemplary embodiment, a prediction model independent of worker who performs an annotation can be learned with high accuracy.

That is, in this exemplary embodiment, the worker model generation unit 1321 learns a worker model corresponding to each worker ID, referring to the input data and the response data. Here, among the response data, the record of the “unknown” response and the corresponding input data are used for learning the worker model. This allows for the use of a larger amount of input data compared to the case where the worker model is learned excluding the “unknown” responses. Further, the prediction accuracy of the worker model can be further improved because the “unknown” responses are near the decision boundary of the worker model.

Furthermore, in this exemplary embodiment, the worker importance calculation unit 1322 refers to the response data and the information of the worker model to adjust the worker importance. This allows a higher level of importance to be given to appropriate workers than when the worker model is handled uniformly. By referring to the worker importance calculated by the worker importance calculation unit 1322 and the information of the worker model, the prediction model update unit 1323 can further improve the prediction accuracy of the prediction model.

### Exemplary Embodiment 4

Next, a fourth exemplary embodiment of the present invention will be described. The fourth exemplary embodiment describes a configuration of a prediction system that predicts a response of a user using the prediction model generated in the third exemplary embodiment. The prediction system of this exemplary embodiment generates a worker model by repeating the process of step S13 to step S16 above, for example. Then, the prediction system predicts the output value corresponding to test data when the test data is input. It should be noted that the prediction system of the fourth exemplary embodiment of the present invention also outputs a predicted value of a response corresponding to test data by a worker of the specified worker ID, when the test data and the worker ID are input.

FIG. 12 is a block diagram showing a configuration example of a prediction system of a fourth exemplary embodiment according to the exemplary aspect of the present invention. The same sign as in FIG. 10 is added to the same configuration as in the third exemplary embodiment, and the description is omitted. The prediction system 11a of the third exemplary embodiment comprises the data input unit 12, the processing unit 13, the storage unit 14, and the result output unit 15, and further comprises a test data input unit 16, a prediction unit 17, and a prediction result output unit 18.

Here, it is assumed that the processing unit 13 has completed the learning process described in the third exemplary embodiment, and the worker model and the prediction model have been generated.

The test data input unit 16 receives input of test data. The input of the test data may include a worker ID. If the worker IDs are not included, the prediction result output unit 18 described below may output results of predicting a response of the worker corresponding to all worker IDs in the response data.

The test data input unit 16 may access an external device (not shown) to obtain the test data, for example. The test data input unit 16 may also be an input interface through which the test data is input.

The content of the test data to be input is the same as in the second exemplary embodiment.

The prediction unit 17 predicts an output value for new input data included in the test data using a prediction model or a worker model corresponding to a specified worker ID. The prediction unit 17 may refer to the information of the learned worker model when using the prediction model for prediction. For example, the prediction unit 17 may predict the output value by adding a weight to the classifier for each worker and taking a majority vote.

Similar to the prediction system of the second exemplary embodiment, the prediction unit 17 may output any of the output candidate labels, or may output affiliation probability for each of the output candidate labels.

The prediction result output unit 18 outputs the value predicted by the prediction unit 17 in the same manner as the prediction system of the second exemplary embodiment. The manner in which the prediction result output unit 18 outputs the predicted value is not particularly limited.

The test data input unit 16, the prediction unit 17 and the prediction result output unit 18 are also realized by a processor of a computer that operates according to a program (prediction program), for example.

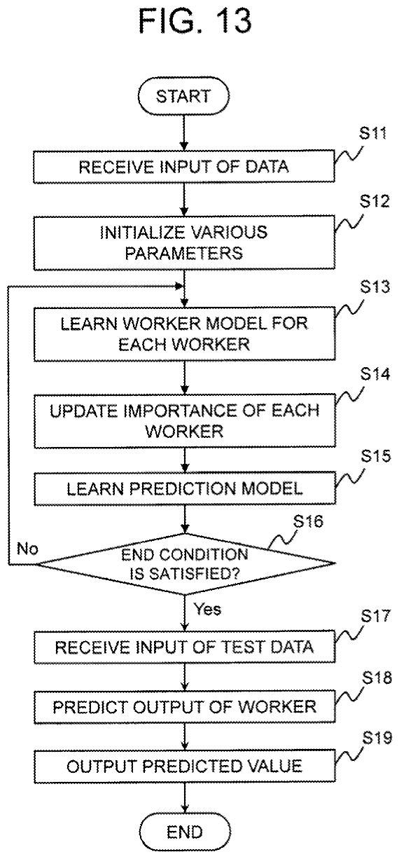

Next, the operation of the prediction system of this exemplary embodiment will be described. FIG. 13 is a flowchart showing an operation example of the prediction system of the fourth exemplary embodiment. The process up to the generation of the worker model and the prediction model is the same as the processes from step S11 to step S16 illustrated in FIG. 11.

The test data input unit 16 receives input of test data (step S17). The prediction unit 17 predicts the output for the test data using the learned worker model or the prediction model (step S18). Then, the prediction result output unit 18 outputs the value predicted by the prediction unit 17 (step S19).

As described above, in this exemplary embodiment, the test data input unit 16 receives input of test data, and the prediction unit 17 predicts an output for the test data using the learned worker model or the prediction model. Thus, in addition to the effect of the third exemplary embodiment, the response to the test data can be predicted.

In other words, according to this exemplary embodiment, the output corresponding to the given test data can be predicted with high accuracy using a prediction model. In addition, according to this exemplary embodiment, based on the given test data and the specified worker ID, the response of the worker corresponding to the worker ID can be predicted with high accuracy using a worker model.

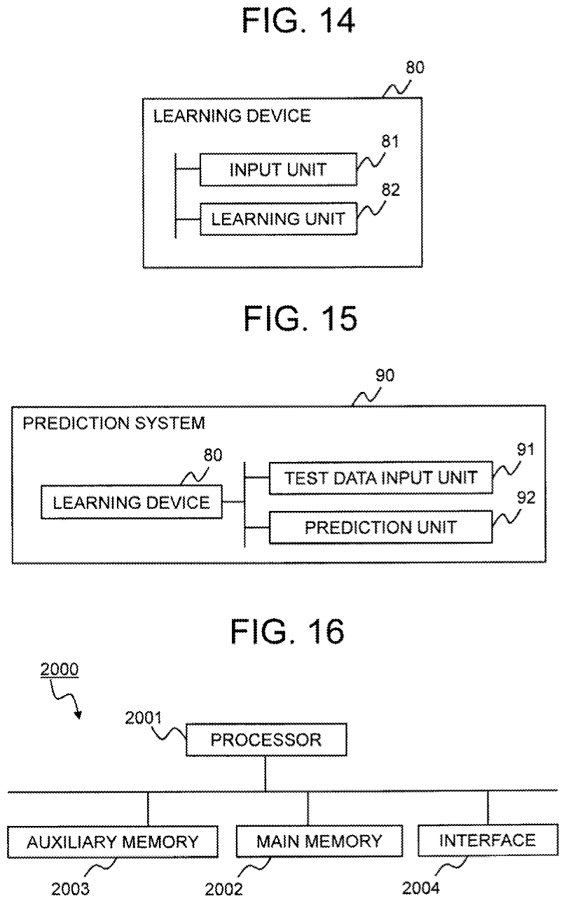

Next, an overview of the present invention will be described. FIG. 14 is a block diagram showing an overview of a learning device according to the exemplary aspect of the present invention. The learning device 80 (the learning device 1, the learning device 11) according to the exemplary aspect of the present invention comprises an input unit 81 (for example, the data input unit 2) which receives input of response data with a response attached to input data by each worker, and a learning unit 82 (for example, the processing unit 3) which learns a worker model which is a model that predicts a response to new input data using the input response data, for each worker.

The input unit 81 receives input of both response data of first response data in which a label included in output candidate label data indicating a candidate label to be assigned to the input data is assigned to the input data, and second response data in which a label (for example, “unknown”) not included in the output candidate label data is assigned to the input data, and the learning unit 82 learns the worker model using the both response data of the first response data and the second response data.

With such a configuration, it is possible to learn a worker model for predicting a worker response with high accuracy.

The learning unit 82 may also learn the worker model based on a loss function including a loss term that evaluates an output of the worker model for the second response dat.

Specifically, the learning unit 82 may learn the worker model of the worker based on the loss function including the loss term that evaluates a proximity of the second response data and a separation boundary that separates an input group of data by the worker.

In addition, the learning device 80 (for example, the learning device 11) comprises a worker importance calculation unit (for example, the worker importance calculation unit 1322) which calculates, for each worker, worker importance indicating a degree of reliability of the worker model according to the number of responses to the second response data by the worker, and a prediction model generation unit (for example, the prediction model update unit 1323) which generates a prediction model that predicts a value of output corresponding to the input data from among output candidates indicated by the output candidate label data, based on the worker model and the calculated worker importance.

Specifically, the worker importance calculation unit may calculate the worker importance so that the worker importance is higher the lesser the second response data.

The prediction model generation unit may also weight the worker model by the corresponding worker importance and generates the prediction model using the weighted worker model.

FIG. 15 is a block diagram showing an overview of a prediction system according to the exemplary aspect of the present invention. The prediction system 90 according to the exemplary aspect of the present invention comprises a learning device 80 (for example, the learning device 1, the learning device 11) described above, a test data input unit 91 (for example, the test data input unit 6, the test data input unit 16) which receives input of test data, and a prediction unit 92 (for example, the prediction unit 7, the prediction unit 17) which predicts an output of the worker for the test data, using a worker model learned by the learning device 80.

With such a configuration, the response to the test data of the worker can be predicted.

The prediction unit 92 may also predict the output of the test data using the worker model of the worker when the test data input unit 91 receives the input of information identifying the worker.

The prediction unit 92 may predict an output for the test data using a worker model or a prediction model learned by the learning device 80.

FIG. 16 is a summarized block diagram showing a configuration of a computer for at least one exemplary embodiment. The computer 2000 comprises a processor 2001, a main memory 2002, an auxiliary memory 2003, and an interface 2004.

The above-described learning device 80 is implemented in the computer 2000. The operation of each of the above-described processing units is stored in the auxiliary memory 2003 in a form of a program (learning program). The processor 2001 reads the program from the auxiliary memory 2003, deploys the program to the main memory 2002, and executes the above-described processing according to the program.

In at least one exemplary embodiment, the auxiliary memory 2003 is an example of a non-transitory tangible medium. Other examples of non-transitory tangible media include a magnetic disk, an optical magnetic disk, a CD-ROM (Compact Disc Read only memory), a DVD-ROM (Read-only memory), a semiconductor memory, and the like. When the program is transmitted to the computer 2000 through a communication line, the computer 2000 receiving the transmission may deploy the program to the main memory 2002 and perform the above process.

The program may also be one for realizing some of the aforementioned functions. Furthermore, the program may be a so-called differential file (differential program), which realizes the aforementioned functions in combination with other programs already stored in the auxiliary memory 2003.

A part of or all of the above exemplary embodiments may also be described as, but not limited to, the following supplementary notes.

(Supplementary note 1) A learning device comprising:
an input unit which receives input of response data with a response attached to input data by each worker; and
a learning unit which learns a worker model which is a model that predicts a response to new input data using the input response data, for each worker, wherein
the input unit receives input of both response data of first response data in which a label included in output candidate label data indicating a candidate label to be assigned to the input data is assigned to the input data, and second response data in which a label not included in the output candidate label data is assigned to the input data, and
the learning unit learns the worker model using the both response data of the first response data and the second response data.

(Supplementary note 2) The learning device according to Supplementary note 1, wherein
the learning unit learns the worker model based on a loss function including a loss term that evaluates an output of the worker model for the second response data.

(Supplementary note 3) The learning device according to Supplementary note 2, wherein
the learning unit learns the worker model of the worker based on the loss function including the loss term that evaluates a proximity of the second response data and a separation boundary that separates an input group of data by the worker.

(Supplementary note 4) The learning device according to any one of Supplementary notes 1 to 3, further comprising:
a worker importance calculation unit which calculates, for each worker, worker importance indicating a degree of reliability of the worker model according to the number of responses to the second response data by the worker; and
a prediction model generation unit which generates a prediction model that predicts a value of output corresponding to the input data from among output candidates indicated by the output candidate label data, based on the worker model and the calculated worker importance.

(Supplementary note 5) The learning device according to Supplementary note 4, wherein
the worker importance calculation unit calculates the worker importance so that the worker importance is higher the lesser the second response data.

(Supplementary note 6) The learning device according to any one of Supplementary notes 1 to 5, wherein
the prediction model generation unit weights the worker model by the corresponding worker importance and generates the prediction model using the weighted worker model.

(Supplementary note 7) A prediction system comprising:
the learning device according to any one of Supplementary notes 1 to 6;
a test data input unit which receives input of test data; and
a prediction unit which predicts an output of the worker for the test data, using a worker model learned by the learning device.

(Supplementary note 8) The prediction system according to Supplementary note 7, wherein
the prediction unit predicts output of the test data using the worker model of the worker when the test data input unit receives input of information identifying the worker.

(Supplementary note 9) A prediction system comprising:
a learning device according to any one of Supplementary notes 4 to 6;
a test data input unit which receives an input of test data; and
a prediction unit which predicts an output for the test data using a worker model or a prediction model learned by the learning device.

(Supplementary note 10) A learning method comprising:
receiving input of response data with a response attached to input data by each worker;
learning a worker model which is a model that predicts a response to new input data using the input response data, for each worker;
when receiving the input of the response data, receiving input of both response data of first response data in which a label included in output candidate label data indicating a candidate label to be assigned to the input data is assigned to the input data, and second response data in which a label not included in the output candidate label data is assigned to the input data; and
learning the worker model using the both response data of the first response data and the second response data.

(Supplementary note 11) The learning method according to Supplementary note 10, wherein
learning the worker model based on a loss function including a loss term that evaluates an output of the worker model for the second response data.

(Supplementary note 12) A prediction method comprising:
performing a learning process based on the learning method according to Supplementary note 10 or Supplementary note 11;
receiving input of test data; and
predicting an output of the worker for the test data, using a worker model learned by the learning process.

(Supplementary note 13) The prediction method according to Supplementary note 12, wherein
predicting output of the test data using the worker model of the worker when the test data input unit receives input of information identifying the worker.

(Supplementary note 14) A learning program causing a computer to execute:
an input process of receiving input of response data with a response attached to input data by each worker; and
a learning process of learning a worker model which is a model that predicts a response to new input data using the input response data, for each worker, wherein
in the input process, the learning program causes the computer to receive input of both response data of first response data in which a label included in output candidate label data indicating a candidate label to be assigned to the input data is assigned to the input data, and second response data in which a label not included in the output candidate label data is assigned to the input data, and
in the learning process, the learning program causes the computer to learn the worker model using the both response data of the first response data and the second response data.

(Supplementary note 15) The learning program according to Supplementary note 14, wherein
the learning program causes the computer to learn the worker model based on a loss function including a loss term that evaluates an output of the worker model for the second response data, in the learning process.

(Supplementary note 16) A prediction program causing a computer to execute
the learning program according to Supplementary note 14 or Supplementary note 15, wherein
the prediction program further causes the computer to execute:
a test data input process of receiving input of test data; and
a prediction process of predicting an output of the worker for the test data using the worker model learned by executing the learning program.

(Supplementary note 17) The prediction program according to Supplementary note 16, wherein
the prediction program causes the computer to predict output of the test data using the worker model of the worker when the test data input unit receives input of information identifying the worker, in the prediction process.

### INDUSTRIAL APPLICABILITY

The present invention is suitably applied to a learning device for learning a model for prediction using the results of worker responses obtained by crowdsourcing or the like, and a prediction system for making prediction using the learned model. For example, the present invention can be applied to a learning device for a prediction model for predicting a label of data such as an image based on responses collected by a crowdsourcing system or the like as well as a prediction system based on the learned prediction model.

### REFERENCE SIGNS LIST

1, 11 Learning device
2, 12 Data input unit
3, 13 Processing unit
4, 14 Storage unit
5, 15 Result output unit
6, 16 Test data input unit
7, 17 Prediction unit
8, 18 Prediction result output unit
1a, 11a Prediction system
132 Model learning unit
1321 Worker model generation unit
1322 Worker importance calculation unit
1323 Prediction model update unit
1325 End determination unit
31, 131 Initialization unit
32 Worker model generation unit
321 Worker model update unit
322 End determination unit

What is claimed is:

1. A learning device comprising a hardware processor configured to execute a software code to:
receive input of response data with a response attached to input data by each worker; and
learn a worker model to predict a response to new input data using the input response data, for each worker, wherein the hardware processor is configured to execute a software code to:
receive input of first response data in which a label included in output candidate label data indicating a candidate label to be assigned to the input data is assigned to the input data, and second response data in which a label not included in the output candidate label data is assigned to the input data; and
learn the worker model using the first response data and the second response data.

2. The learning device according to claim 1, wherein the hardware processor is configured to execute a software code to
learn the worker model based on a loss function including a loss term that evaluates an output of the worker model for the second response data.

3. The learning device according to claim 2, wherein the hardware processor is configured to execute a software code to
learn the worker model of the worker based on the loss function including the loss term that evaluates a proximity of the second response data and a separation boundary that separates an input group of data by the worker.

4. The learning device according to claim 1, wherein the hardware processor is configured to execute a software code to:
calculate, for each worker, worker importance indicating a degree of reliability of the worker model according to the number of responses to the second response data by the worker; and
generate a prediction model that predicts a value of output corresponding to the input data from among output candidates indicated by the output candidate label data, based on the worker model and the calculated worker importance.

5. The learning device according to claim 4, wherein the hardware processor is configured to execute a software code to
calculate the worker importance so that the worker importance is higher the lesser the second response data.

6. The learning device according to claim 1, wherein the hardware processor is configured to execute a software code to
weight the worker model by the corresponding worker importance and generate the prediction model using the weighted worker model.

7. A prediction system comprising:
the learning device according to claim 1;
a test data input unit which receives input of test data; and
a prediction unit which predicts an output of the worker for the test data, using a worker model learned by the learning device.

8. The prediction system according to claim 7, wherein
the prediction unit predicts output of the test data using the worker model of the worker when the test data input unit receives input of information identifying the worker.

9. A prediction system comprising:
a learning device according to claim 4;
a test data input unit which receives an input of test data; and
a prediction unit which predicts an output for the test data using a worker model or a prediction model learned by the learning device.

10. A learning method comprising:
receiving input of response data with a response attached to input data by each worker;
learning a worker model to predict a response to new input data using the input response data, for each worker;
when receiving the input of the response data, receiving input of first response data in which a label included in output candidate label data indicating a candidate label to be assigned to the input data is assigned to the input data, and second response data in which a label not included in the output candidate label data is assigned to the input data; and
learning the worker model using the first response data and the second response data.

11. The learning method according to claim 10, wherein
learning the worker model based on a loss function including a loss term that evaluates an output of the worker model for the second response data.

12. A prediction method comprising:
performing a learning process based on the learning method according to claim 10;
receiving input of test data; and
predicting an output of the worker for the test data, using a worker model learned by the learning process.

13. The prediction method according to claim 12, wherein
predicting output of the test data using the worker model of the worker when receiving input of information identifying the worker.

14. A non-transitory computer readable information recording medium storing a learning program, when executed by a processor, that performs a method for:
receiving input of response data with a response attached to input data by each worker;
learning a worker model to predict a response to new input data using the input response data, for each worker;
when receiving the input of the response data, receiving input of first response data in which a label included in output candidate label data indicating a candidate label to be assigned to the input data is assigned to the input data, and second response data in which a label not included in the output candidate label data is assigned to the input data; and
learning the worker model using the first response data and the second response data.

15. The non-transitory computer readable information recording medium according to claim 14, wherein
learning the worker model based on a loss function including a loss term that evaluates an output of the worker model for the second response data.

16. A non-transitory computer readable information recording medium storing a prediction program, when executed by a processor, that performs a method for
performing a learning process based on the learning method according to claim 14;
receiving input of test data; and
predicting an output of the worker for the test data using the worker model learned by executing the learning program.

17. The non-transitory computer readable information recording medium according to claim 16, wherein
predicting output of the test data using the worker model of the worker when receiving input of information identifying the worker.
